(19) United States
(12) Patent Application Publication
(10) Pub. No.: US 2025/0253073 A1
(43) Pub. Date: Aug. 7, 2025

(54) PANEL BOARD HAVING INSULATING PLATE

(71) Applicant: LS ELECTRIC CO., LTD., Anyang-si (KR)

(72) Inventor: Sunkook KIM, Anyang-si (KR)

(21) Appl. No.: 19/032,738

(22) Filed: Jan. 21, 2025

(30) Foreign Application Priority Data
Feb. 6, 2024 (KR) 10-2024-0018310

(51) Int. Cl. H01B 17/18; H01B 17/00; H02B 1/052; H02B 1/20

(52) U.S. Cl. CPC H01B 17/18; H01B 17/005; H02B 1/052; H02B 1/205

(57) ABSTRACT

Provided is a panel board having an insulating plate, and more particularly, a panel board having an insulating plate with improved insulation between bus bars. In a panel board having an insulating plate according to an embodiment, inter-phase part partition walls are formed at an inter-phase part of the insulating plate at a certain gap, thereby increasing an inter-phase creepage distance between mother bus bars, resulting in improving insulation performance.

### CROSS-REFERENCE TO RELATED APPLICATION

Pursuant to 35 U.S.C. § 119(a), this application claims the benefit of the earlier filing date and the right of priority to Korean Patent Application No. 10-2024-0018310, filed on Feb. 6, 2024, the contents of which are incorporated by reference herein in their entirety.

### FIELD

The present disclosure relates to a panel board having an insulating plate, and more particularly, to a panel board having an insulating plate with improved insulation between bus bars.

### BACKGROUND

In general, a panel board is a device for distributing and managing power from a main bus. As for power lines from distribution lines to loads, a main line through which electricity flows is called a main bus (mother line). To distribute and manage power in indoor distribution lines, overcurrent circuit breakers of branch circuits, which are installed at portions diverged from the main bus to the respective branch circuits, are housed in one place. This place is a panel board.

A distribution panel, also known as an electrical panel or circuit breaker panel, is a component of a power system that acts as a distribution point for a power circuit. In the panel board, circuits are grouped and protected by circuit breakers designed to trip the circuits when a current exceeds a proper level. This helps suppress damage to the power system and reduce the risk of fire. Panel boards generally play a vital role in safely distributing and managing power in buildings.

Typically, a panel board is structured with branch bus bars fastened vertically to mother bus bar. That is, branch bus bars are arranged in a direction orthogonal to the mother bus bar, which is arranged in a row, and coupled to each other. A high-level circuit breaker is installed on the mother bus bar, and a low-level circuit breaker is installed on each branch bus bar.

Rail-type bus bars are applied to easily change installation locations of branch bus bars in the panel board. A rail-type panel board has a structure in which a mother bus bar is formed in a rail shape and branch bus bars are mounted in rail grooves of the mother bus bar to be slidable in the rail grooves. The mother bus bar and branch bus bars are usually coupled by bolts in the rail-type panel board.

As such, the branch bus bars are configured to be easily movable in a longitudinal direction of the mother bus bar. However, the branch bus bars may be rotated when bolts are not fully tightened to the mother bus bar in case that the branch bus bars are fastened to the mother bus bar by the bolts, when a circuit breaker is not fastened, or when a maintenance operation is carried out. This may cause a major accident such as a short-circuit between phases.

FIG. 1 illustrates a rail-type panel board according to the related art.

A base plate 60 and a frame 65 forming a panel board structure form a basic support structure. Here, the base plate 60 is formed of iron.

Mother bus bars 30 are installed on a base support 70 on the base plate 60. A high-level circuit breaker 10 is connected to the mother bus bars 30.

Branch bus bars 40 are installed in a direction orthogonal to the mother bus bars 30.

Low-level circuit breakers (branch circuit breakers) 20 are connected to the corresponding branch bus bars 40. The low-level circuit breakers 20 are connected to respective loads. Accordingly, a current applied to the corresponding mother bus bar 30 is transmitted to the loads through the corresponding branch bus bars 40 and lower circuit breakers 20.

The mother bus bar 30 and the branch bus bars 40 are coupled by fastening screws 50.

Here, the mother bus bar 30 and the branch bus bar 40 are axially connected by the fastening screw 50. Accordingly, when a space where the circuit breaker is to be connected is empty without the circuit breaker connected, the branch bus bar 40 may not be supported and may be rotated around a coupling axis of the mother bus bar 30. Additionally, the branch bus bar 40 may be rotated or twisted by user's careless actions.

This may cause incomplete coupling between the mother bus bar 30 and the branch bus bar 40, which may bring about an insufficient current flow or, in severe cases, a short-circuit accident.

In some examples, a sufficient insulation distance must be maintained between phases of the mother bus bar. The mother bus bar 30 has three phases or four phases arranged in parallel. Accordingly, a large current flows between the adjacent mother bus bars 30, so an inter-phase distance must be strictly maintained. For example, the USA standard (UL67) requires for a minimum creepage distance of at least two inches. That is, sufficient insulation performance must be guaranteed between the mother bus bars.

### SUMMARY

The disclosure has been derived to solve the above-mentioned problems, and an aspect of the disclosure is to provide a panel board having an insulating plate with an improved coupling force between a mother bus bar and branch bus bars while securing insulation performance between the mother bus bars.

According to an aspect of the disclosure, there is provided a panel board including a base plate, an insulating plate coupled to the base plate and including a plurality of bus bar mounting grooves formed in parallel, and rail-type mother bus bars inserted into the plurality of bus bar mounting grooves, respectively, wherein the insulating plate includes an inter-phase part partition wall formed at an inter-phase part between the bus bar mounting grooves to be higher than a height of the corresponding mother bus bar.

Here, the insulating plate includes an assembly protrusion portion protruding from one end of a lower surface of the insulating plate, and an assembly cut portion formed by cutting another end of the lower surface of the insulating plate.

The insulating plate includes a plurality of assembly protrusions protruding forward from one surface of the insulating plate, and a plurality of assembly grooves formed as grooves in another surface of the insulating plate to correspond to the plurality of assembly protrusions, respectively.

The insulating plate includes an inner coupling block formed on a front end of a side wall of the insulating plate, and an outer coupling block formed on a rear end of the side wall to correspond to the inner coupling block.

The bus bar mounting groove includes a bus bar fastening hole formed such that the mother bus bar is coupled.

A groove side wall forming a side surface of the bus bar mounting groove protrudes to a certain height, and the height of the groove side wall is lower than a height of the mother bus bar.

The inter-phase part partition wall is arranged at a certain gap from the groove side wall.

A gap groove of a certain depth is formed between the inter-phase part partition wall and the groove side wall.

The inter-phase part partition wall is provided as a pair in a symmetrical manner at the inter-phase part between two adjacent phases.

According to another aspect of the disclosure, there is provided a panel board including a base plate, an insulating plate coupled to the base plate and including a plurality of bus bar mounting grooves formed in parallel, and rail-type mother bus bars inserted into the plurality of bus bar mounting grooves, respectively, wherein the insulating plate includes a double protrusion portion arranged at an inter-phase part between the bus bar mounting grooves adjacent to each other, and the double protrusion portion includes a groove side wall protruding to a certain height from a side surface of the bus bar mounting groove, an inter-phase part partition wall protruding from the inter-phase part, and a gap groove formed between the groove side wall and the inter-phase part partition wall.

A height of the groove side wall is lower than a height of the mother bus bar.

The inter-phase part partition wall is higher than a height of the groove side wall and a height of the mother bus bar.

The inter-phase part partition wall is provided as a pair in a symmetrical manner at the inter-phase part between two adjacent phases.

In a panel board having an insulating plate according to an embodiment, inter-phase part partition walls are formed on an inter-phase part of the insulating plate at a certain gap, thereby increasing an inter-phase creepage distance of a mother bus bar, resulting in improving insulation property.

Here, the inter-phase part partition walls are formed higher than a height of the mother bus bar, which results in an increase in creepage distance for improving insulation performance. The inter-phase part partition walls are formed higher than the height of the mother bus bar, thereby protecting adjacent devices or users.

The inter-phase part partition wall is provided as a pair in a symmetrical manner at the inter-phase part, which further contributes to increasing the creepage distance.

A groove side wall forming a side wall of a bus bar mounting groove of the insulating plate protrudes in parallel to the inter-phase part partition wall, contributing to increasing the creepage distance.

A gap groove of a certain depth is formed between the inter-phase part partition wall and the groove side wall, contributing to increasing the creepage distance.

In this way, a creepage distance between adjacent phases increases by a double protrusion structure formed by an inter-phase part partition wall, a groove side wall, and a gap groove. Therefore, a linear distance between the adjacent phases may be reduced. That is, a small gap may be made between adjacent bus bar mounting grooves, which may help reduce an overall size of the panel board and allow for manufacturing a compact panel board.

In some embodiments, the insulating plate includes an assembly protrusion portion and an assembly cut portion formed on front and rear ends of the insulating plate, respectively, thereby improving assembly and bonding properties.

In addition, the insulation plate includes assembly protrusions and assembly grooves on the front and rear ends to improve assembly efficiency and ensure alignment between adjacent insulation plates. This facilitates the insertion and coupling of a mother bus bar arranged on the plurality of insulating plates.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a perspective view of a rail-type panel board according to the related art; and

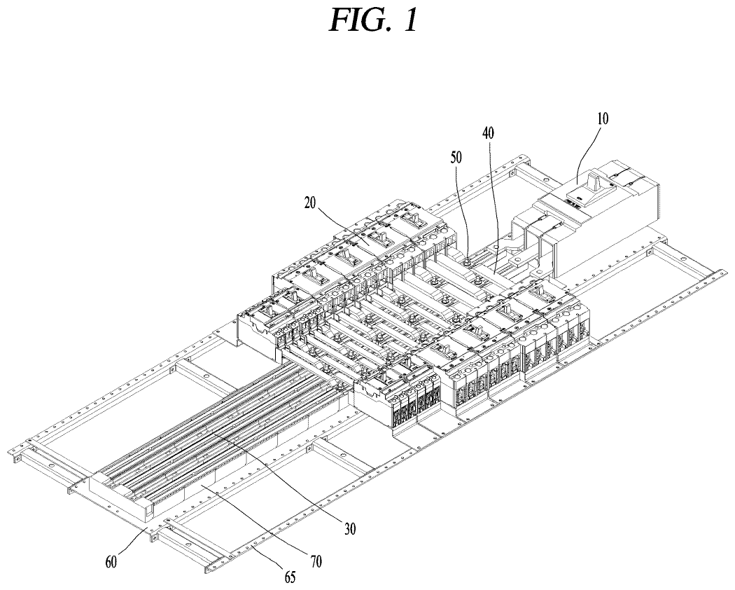

FIGS. 2 and 8 are views of a rail-type panel board according to the disclosure, where FIG. 2 is a perspective view of a rail-type panel board according to an embodiment;

FIG. 3 is a detailed view of a coupling portion between a mother bus bar and branch bus bars in FIG. 2;

FIG. 4 is a partial top view of the panel board;

FIG. 5 is a partial perspective view of a base plate, an insulating plate, and a mother bus bar;

FIG. 6 is a cross-sectional view of FIG. 5; and

FIGS. 7 and 8 are perspective views of an insulating plate applied to an embodiment of the disclosure, viewed in different directions.

### DETAILED DESCRIPTION

Hereinafter, preferred embodiments of the disclosure will be described with reference to the attached drawings. However, embodiments of the disclosure will be described in more detail with reference to the accompanying drawings so as to allow those skilled in the art to easily implement the disclosure, and it should be understood that the technical idea and scope of the disclosure are not limited to those preferred embodiments and drawings.

The terms “member” or “part” used herein to refer to components are not used for any limiting purpose and may be omitted.

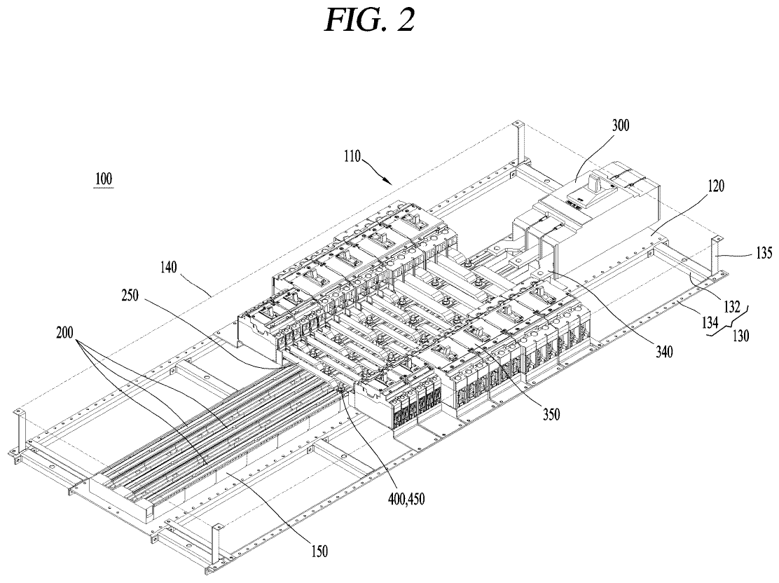

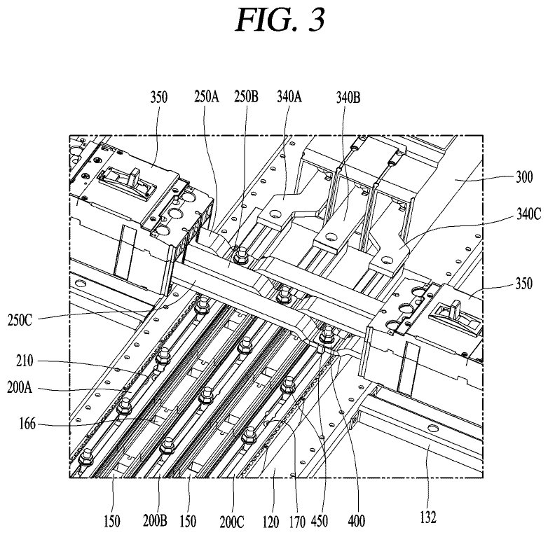

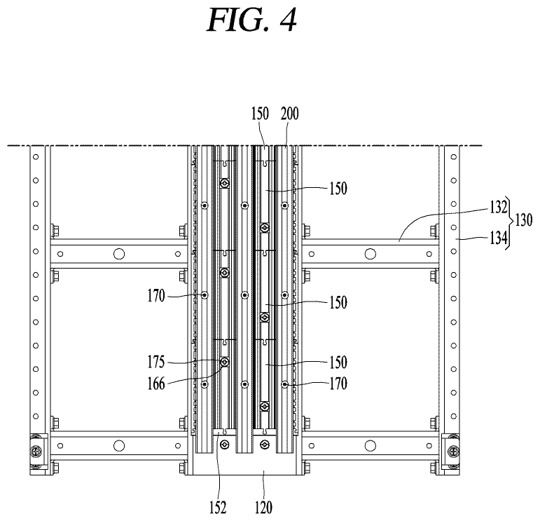

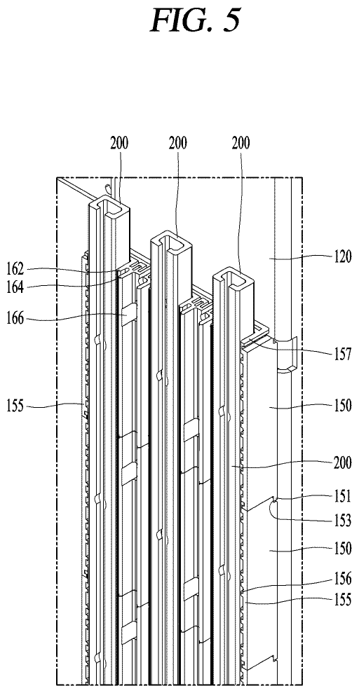

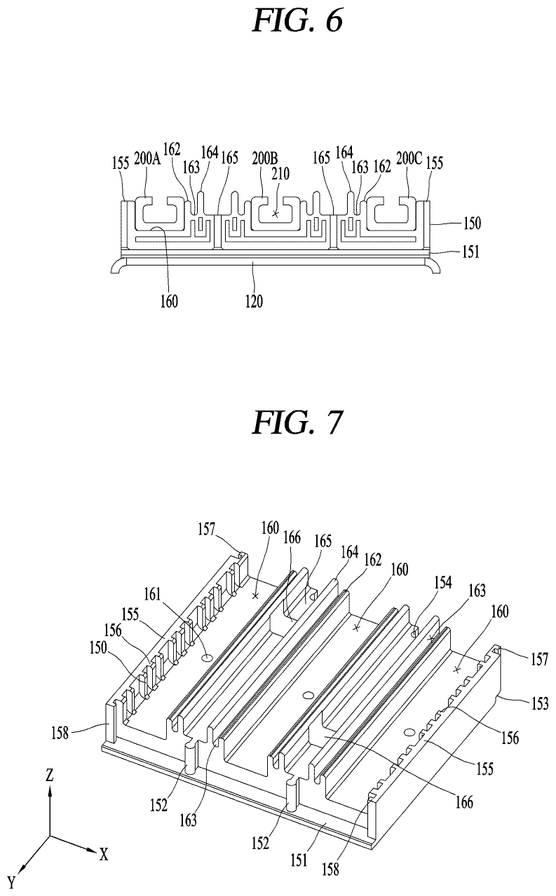

FIG. 2 is a perspective view of a rail-type panel board according to an embodiment, FIG. 3 is a detailed view of a coupling portion between a mother bus bar and branch bus bars in FIG. 2, FIG. 4 is a partial top view of the panel board, FIG. 5 is a partial perspective view of a base plate, an insulating plate, and a mother bus bar, and FIG. 6 is a cross-sectional view of FIG. 5. Hereinafter, a panel board having an insulating plate according to each embodiment will be described in detail.

A panel board 100 having an insulating plate according to an embodiment includes a base plate 120, an insulating plate 150 coupled to the base plate 120 and having a plurality of bus bar mounting grooves 160 formed in parallel, and rail-type mother bus bars 200 inserted into the plurality of bus bar mounting grooves 160, respectively, and the insulating plate 150 includes inter-phase partition walls 164 formed at an inter-phase part 165 between the bus bar mounting grooves 160 to be higher than a height of the mother bus bar 200.

The components that constitute the panel board 100 will be explained in order.

A panel board case 110 is provided. The panel board case 110 is provided to accommodate, install, and support components such as bus bars and circuit breakers.

The panel board case 110 includes a base plate 120, a panel board frame 130 coupled to the base plate 120, and a panel board cover 140.

The base plate 120 is formed in the shape of a rectangular plate. The base plate 120 is installed on a rear panel of the panel board case 110. Mother bus bars 200 and branch bus bars 250 are installed on the base plate 120. A first circuit breaker 300 and second circuit breakers 350 are installed on the base plate 120.

The base plate 120 may be made of a panel in a shape like ‘⊏’. Main components, such as the bus bars 200 and 250 and the circuit breakers 300 and 350 are installed on a middle plate surface, which occupies most of the area of the base plate 120. The panel board frame 130 and the like are coupled to opposite side surfaces of the base plate 120.

A plurality of installation fastening holes are formed in the base plate 120 so that the above components may be coupled.

The base plate 120 may be formed long in a vertical direction. Accordingly, the second circuit breakers 350 connected to loads may be arranged in parallel in the vertical direction. In this instance, the second circuit breakers 350 may be arranged on opposite sides of the base plate 120.

The first circuit breaker 300 connected to the mother bus bar 200 may be arranged on an upper end portion of the base plate 120.

The panel board frame 130 is provided. The panel board frame 130 is coupled to the base plate 120 to expand the size of the panel board, and the second circuit breakers 350 and the like are installed and supported on the panel board frame 130.

The panel board frame 130 may include a plurality of horizontal beams 132 arranged horizontally and a plurality of vertical beams 134 arranged vertically.

The horizontal beam 132 and the vertical beam 134 may be formed in a shape like ‘⊏’ or ‘¬’.

The horizontal beams 132 may be directly coupled to the base plate 120, and the vertical beams 134 may be coupled to outer ends of the horizontal beams 132 to form an outer portion of the panel board.

A plurality of fastening holes are formed in the horizontal beams 132 and the vertical beams 134 to install components.

Cover supports 135 are provided. The cover supports 135 support the panel board cover 140. The cover support 135 is arranged at each corner of the panel board frame 130, i.e., at a point where the horizontal beam 132 and the vertical beam 134 meet. The cover support 135 is installed in a direction orthogonal to the horizontal beam 132 and the vertical beam 134. Therefore, the horizontal beams 132, the vertical beams 134, and the cover supports 135 form a three-dimensional space.

The cover supports 135 are formed longer than the heights of the first circuit breaker 300 and the second circuit breaker 350, such that the first circuit breaker 300 and the second circuit breaker 350 are accommodated inside the panel board cover 140.

The panel board cover 140 is provided. The panel board cover 140 may be formed in a shape of a panel or plate. The panel board cover 140 may be formed in a shape of a plate or a box with an open bottom, installed on the cover supports 135. The panel board cover 140 protects the components, such as the bus bars 200 and 250 and the circuit breakers 300 and 350 and suppresses an introduction of foreign substances. The distribution panel cover 140 ensures user safety by suppressing live-wire parts from being exposed to the user.

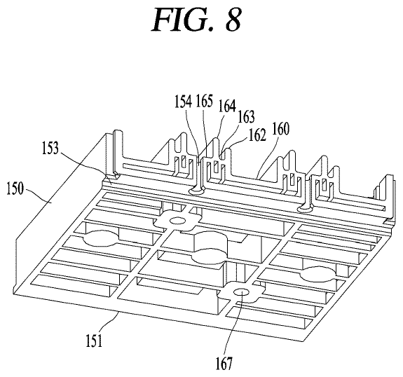

The insulating plate 150 is provided. The insulating plate 150 illustrated in FIGS. 7 and 8 is additionally referenced.

The insulating plate 150 is arranged for insulation between the base plate 120 and the mother bus bar 200. The insulating plate 150 is formed of an insulating material. The insulating plate 150 is installed on the base plate 120. The insulating plate 150 is arranged to form an insulating layer between the base plate 120 and the bus bars 200 and 250 after installing the mother bus bars 200 and the branch bus bars 250.

The insulating plate 150 may have a width (a width in a left-right direction) which corresponds to the width of the base plate 120.

The insulating plate 150 has a length (a length in an up-down direction or front-back direction) which is shorter than the length of the base plate 120.

The width and length of the insulating plate 150 may be approximately similar, and thus the shape of the insulating plate 150, viewed from the top, may be formed similar to a square.

The insulating plate 150 is provided in plurality assembled in series and installed to secure an entire length.

To enable stable and easy connection or assembly of the insulating plates 150, an assembly protrusion portion 151 protrudes from one end of a lower surface of the insulating plate 150, and an assembly cut portion 153 is formed by cutting another end of the lower surface of the insulating plate 150.

In FIGS. 7 and 8, it is shown that the assembly protrusion portion 151 is formed on a front side (front end) of the insulating plate 150 and the assembly cut portion 153 is formed on a rear side (rear end) of the insulating plate 150. Here, the assembly protrusion portion 151 and the assembly cut portion 153 are formed to correspond to each other.

The insulating plates 150 may be successively connected in the up-down direction in a manner that the assembly protrusion portion 151 of one insulating plate 150 is aligned with the assembly cut portion 153 of another adjacent insulating plate 150. In FIGS. 3 to 5, the insulating plates 150 connected in succession in this manner are clearly shown.

When viewed from the side, the assembly protrusion portion 151 and the assembly cut portion 151 may form step surfaces (see FIG. 5). Accordingly, one insulating plate 150 may be arranged and another insulating plate 150 adjacent to the one insulating plate 150 may be arranged such that the assembly portions 151 and 153 overlap each other or are fitted to each other. This facilitates the connection task between the adjacent insulating plates 150.

A plurality of assembly protrusions 152 are formed on the assembly protrusion portion 151 to protrude forward (a Y-axis direction in FIG. 7). The corresponding assembly protrusion 152 has a cross-section that is maintained constant in the up-down direction (a Z-axis direction in FIG. 7). The assembly protrusion 152 is arranged on a central portion of the inter-phase part 165. That is, the assembly protrusion 152 is arranged on the central portion of the inter-phase part 165 in an X-axis direction.

The assembly cut portion 153 includes a plurality of assembly grooves 154 formed as grooves in the forward direction (the Y-axis direction in FIG. 7). The corresponding assembly groove 154 has a cross-section which is maintained constant in the up-down direction (the Z-axis direction in FIG. 7). The assembly groove 154 may be arranged to be in contact with the central portion of the inter-phase part 165. Alternatively, the assembly groove 154 is formed in the central portion of the inter-phase part 165. That is, the assembly groove 154 is arranged on the central portion of the inter-phase part 165 in the X-axis direction.

The assembly groove 154 is formed in a shape corresponding to the assembly protrusion 152. The assembly protrusion 152 and the assembly groove 154 are formed to have a constant cross-section in the up-down direction. Accordingly, the connection operation is easily performed by fitting the assembly protrusion 152 to the assembly groove 154 when one insulating plate 150 is arranged and another insulating plate 150 is arranged adjacently such that the assembly portions 151 and 153 are arranged to overlap each other in the up-down direction. As the assembly protrusion 152 is fitted to the assembly groove 154, the one insulating plate 150 and the adjacent insulating plate 150 are easily aligned with each other. By facilitating the alignment between the plurality of insulating plates 150 that are connected in series, the alignment of the bus bar mounting grooves 160 is also well achieved, making it easy to fasten the mother bus bar 200.

Side walls 155 of opposite ends of the insulating plate 150 may be formed at a height corresponding to a groove side wall 162.

A plurality of ribs 156 may be formed on the side walls 155 on the both sides of the insulating plate 150 to support the mother bus bar 200 effectively.

Coupling blocks 157 and 158 may be formed on respective corners of the insulating plate 150. That is, the coupling blocks 157 and 158 are formed on front and rear end portions of the corresponding side wall 155. In this instance, an inner coupling block 158 is arranged on the front end portion of the side wall 155 and an outer coupling block 157 is arranged on the rear end portion of the side wall 155. The inner coupling block 158 and the outer coupling block 157 are fitted to each other. The inner coupling block 158 and the outer coupling block 157 have a cross-section in the shape like ‘⊏’. Accordingly, the inner coupling block 158 defines a groove formed inward and the outer coupling block 157 defines a groove formed outward, such that the inner coupling block 158 and the outer coupling block 157 are fitted to each other.

The bus bar mounting groove 160 is formed in the insulating plate 150. The bus bar mounting groove 160 is formed from front end to rear end of the insulating plate 150 along the front-back direction (the Y-axis direction in FIG. 7).

The bus bar mounting groove 160 is provided in plurality according to the number of mother bus bars 200 to be arranged. Usually, the mother bus bar 200 is provided for three or four phases, so three or four bus bar mounting grooves 160 are arranged in parallel in the insulating plate 150.

The bus bar mounting groove 160 is formed in a shape corresponding to the mother bus bar 200. Typically, the bus bar mounting groove 160 may have a cross-section that is a rectangular shape.

A plurality of bus bar fastening holes 161 are formed in the bus bar mounting groove 160. The mother bus bar 200 is coupled by bus bar fastening members 170 that are fastened to the bus bar fastening holes 161.

To increase a creepage distance, a double protrusion portion is arranged at the inter-phase part 165 between the bus bar mounting grooves 160. Here, the double protrusion portion includes a groove side wall 162 protruding from a side surface of the bus bar mounting groove 160 by a certain height, an inter-phase part partition wall 164 protruding from the inter-phase part 165, and a gap groove 163 formed between the groove side wall 162 and the inter-phase part partition wall 164. The double protrusion portion is arranged on each of opposite sides of the inter-phase part 165.

The groove side wall 162 protrudes by a certain height to define the side surface of the bus bar mounting groove 160. Here, the height of the groove side wall 162 forming the side surface of the bus bar mounting groove 160 is lower than the height of the mother bus bar 200. Accordingly, the mother bus bar 200 is easily mounted in or separated from the bus bar mounting groove 160. In case that the mother bus bar 200 is mounted in the bus bar mounting groove 160, the mother bus bar 200 protrudes from the groove side wall 162, thereby facilitating the coupling work of the branch bus bars 250. Here, the height of the groove side wall 162 and the height of the mother bus bar 200 refer to heights in a state where the mother bus bar 200 is mounted in the bus bar mounting groove 160 (see FIG. 6).

The inter-phase part partition walls 164 protrude from the inter-phase part 165 between the bus bar mounting groove 160 and the adjacent bus bar mounting groove 160. The inter-phase part partition walls 164 are arranged at certain gaps from the groove side walls 162. The inter-phase part partition wall 164 is formed higher than the height of the groove side wall 162 and higher than the height of the mother bus bar 200. Here, the height of the mother bus bar 200 refers to the height of the mother bus bar 200 in the state where the mother bus bar 200 is mounted in the bus bar mounting groove 160.

The inter-phase part partition wall 164 is formed on the inter-phase part 165 to increase the creepage distance for improving insulation performance. In addition, the inter-phase part partition wall 164 is formed higher than the height of the mother bus bar 200 to protect adjacent devices or users.

The gap groove 163 having a certain depth is formed between the inter-phase part partition wall 164 and the groove side wall 162. A bottom surface of the gap groove 163 may be flush with a surface of the inter-phase part 165. The gap grooves 163 contribute, together with the inter-phase part partition walls 164, to increasing the creepage distance between the adjacent mother bus bars 200.

The inter-phase part partition walls 164 are arranged adjacent to the groove side walls 162 of adjacent phases. That is, the pair of (or two) inter-phase part partition walls 164 are arranged symmetrically between the groove side walls 162 of the adjacent phases.

Hereinafter, a path from one mother bus bar 200 to an adjacent mother bus bar 200 is explained based on R phase and S phase.

The path is formed in the following order: R-phase mother bus bar 200A—R-phase groove side wall 162—R-phase inter-phase part partition wall 164—inter-phase part 165—S-phase inter-phase part partition wall 164—S-phase groove side wall 162—S-phase mother bus bar 200B.

Accordingly, the creepage distance between the mother bus bars 200A and 200B of the adjacent phases increases, thereby improving insulation performance. This may result in reducing a linear distance between the adjacent phases. That is, a small gap may be made between the adjacent bus bar mounting grooves 160, which may help reduce the overall size of the panel board and allow for manufacturing a compact panel board.

The inter-phase part 165 includes a plate fastening groove 166 and a plate fastening hole 167.

To couple the insulating plate 150 to the base plate 120, the plate fastening groove 166 is formed in the inter-phase part 165, and the plate fastening hole 167 is formed through a bottom surface of the plate fastening groove 166.

The insulating plate 150 is coupled to the base plate 120 by a plate fastening member 175 inserted into the plate coupling groove 166. The plate fastening groove 166 may be provided for each inter-phase part 165.

The plate fastening hole 167 is formed through the bottom surface of the plate fastening groove 166. The plate fastening member 175 is inserted through the plate fastening hole 167 to couple the insulating plate 150 and the base plate 120.

The mother bus bar 200 is provided. The mother bus bar 200 is e made of a material with good electrical conductivity, such as copper or aluminum. The mother bus bar 200 is connected to a line side, to receive current and supply the current to loads.

The mother bus bar 200 is installed on the base plate 120 in a longitudinal direction of the base plate 120. The mother bus bar 200 is not directly connected to the base plate 120, but is coupled to the insulating plate 150.

The mother bus bar 200 is inserted into the bus bar mounting groove 160 of the insulating plate 150. The mother bus bar 200 is inserted into the bus bar mounting groove 160 of the insulating plate 150 and fixedly coupled by the bus bar fastening member 170.

The mother bus bar 200 is installed along the plurality of insulating plates 150. The plurality of insulating plates 150 are arranged on the base plate 120 in a row along the front-back direction, and the mother bus bar 200 is inserted in the bus bar mounting groove 160 of each insulating plate 150.

The mother bus bar 200 is arranged for each phase. For example, in the case of three phases, a first phase bus bar (R-phase bus bar) 200A, a second phase bus bar (S-phase bus bar) 200B, and a third phase bus bar (T-phase bus bar) 200C may be arranged. The bus bars of the respective phases are arranged on the insulating plates 150 in parallel. However, the bus bars of the respective phases are not in contact with each other.

The mother bus bar 200 is arranged such that one end thereof, for example, an upper end is connected to the first circuit breaker 300.

The mother bus bar 200 may be configured as a rail type. That is, the mother bus bar 200 has a cross-section like ‘▭’, with an opening formed through a central portion of an upper surface of the mother bus bar 200 along the lengthwise direction. Therefore, in view of the cross-section, the mother bus bar 200 includes a rail groove 210 formed in a shape like an upside-down ‘T’. A fastening member 450 is inserted into the corresponding rail groove 210. The branch bus bars 250 are fixed to the mother bus bar 200 by the fastening members 450 mounted in the rail grooves 210. The fastening member 450 may slide along the longitudinal direction of the mother bus bar 200 within the rail groove 210. Accordingly, the position of the branch bus bar 250 coupled to the mother bus bar 200 may change along the longitudinal direction of the mother bus bar 200.

The branch bus bars 250 are provided.

The branch bus bars 250 are made of a material with good electrical conductivity, such as copper or aluminum.

Each branch bus bar 250 is arranged to receive current from the mother bus bar 200 and supply the received current to the corresponding load. That is, the branch bus bar 250 serves to diverge the current from the main bus bar 200.

The branch bus bar 250 is provided for each phase. For example, a first phase branch bus bar 250A, a second phase branch bus bar 250B, and a third phase branch bus bar 250C may be provided.

The branch bus bar 250 is formed in a straight shape overall, but a portion of a middle part of the branch bus bar 250 is bent concavely. The concavely bent portion of the branch bus bar 250 is a portion which is coupled to the mother bus bar 200.

The branch bus bar 250 includes a terminal connection portion coupled to a terminal portion of the second circuit breaker 350 and a mother line connection portion connected to the mother bus bar 200. The terminal connection portion is arranged on each of opposite ends of the branch bus bar 250, and the mother line connection portion is arranged on the concave portion formed on the portion of the middle part of the branch bus bar 250.

A through hole through which the fastening member 450 may be inserted is formed through the branch bus bar 250.

A portion of the branch bus bar 250 except for the terminal connection portion and the mother line connection portion may be coated with a coating member for insulation.

The branch bus bar 250 is coupled in a direction orthogonal to an upper surface of the mother bus bar 200.

The first circuit breaker 300 is provided.

The first circuit breaker 300 allows or blocks a flow of current by determining whether a fault current flows on the mother bus bar 200. That is, the first circuit breaker 300 allows or blocks a current supply to the mother bus bar 200.

A connection conductor 340 connecting the first circuit breaker 300 and the mother bus bar 200 is provided for each phase.

The connection conductor 340 is provided for each phase. For example, a first phase connection conductor (R-phase connecting conductor) 340A, a second phase connection conductor (S-phase connecting conductor) 340B, and a third phase connection conductor (T-phase connection conductor) 340C may be arranged.

The connection conductor 340 may be applied to compensate for a gap difference in case that a gap between terminal portions of the corresponding phases of the first circuit breaker 300 and a gap between the mother bus bars 200 for the corresponding phases.

The second circuit breaker 350 is provided.

The second circuit breaker 350 detects whether there is a fault current flowing from the mother bus bar 200 to the load and blocks the current when the fault current flows. That is, the second circuit breaker 350 allows or blocks a current supply to each load.

The second circuit breaker 350 may be provided for each load. That is, the second circuit breaker 350 is provided in plurality. The plurality of second circuit breakers 350 are arranged in parallel along the mother bus bar 200. The plurality of second circuit breakers 350 may be arranged at each of opposite sides of the mother bus bar 200.

The second circuit breaker 350 is connected to the mother bus bar 200 through the corresponding branch bus bar 250. A terminal portion of the second circuit breaker 350 is connected to the terminal connection portion of the branch bus bar 250.

The fastening member 450 is provided. The fastening member 450 is provided to couple the branch bus bar 250 and the mother bus bar 200. A fastening nut may be coupled in case that the fastening member 450 is formed in a bolt shape.

In a panel board having an insulating plate according to an embodiment of the disclosure, an inter-phase part partition wall is formed at an inter-phase part of the insulating plate at a certain gap, thereby increasing an inter-phase creepage distance between mother bus bars, resulting in improving insulation property.

Here, the inter-phase part partition wall is formed higher than a height of the mother bus bar, which results in an increase in creepage distance for improving insulation performance. The inter-phase part partition walls are formed higher than the height of the mother bus bar, thereby protecting adjacent devices or users.

The inter-phase part partition wall is provided as a pair in a symmetrical manner at the inter-phase part, which further contributes to increasing the creepage distance.

A groove side wall forming a side wall of a bus bar mounting groove of the insulating plate protrudes in parallel to the inter-phase part partition wall, contributing to increasing the creepage distance.

A gap groove of a certain depth is formed between the inter-phase part partition wall and the groove side wall, contributing to increasing the creepage distance.

While the above-described embodiments illustrate the best embodied state for implementing the disclosure, it will be understood by those skilled in the art that various changes and modifications may be made without departing from the scope of the disclosure. Therefore, these embodiments are not intended to limit the technical idea of the disclosure but are merely illustrative. Therefore, it should be understood that the scope of the technical idea of the disclosure is not limited by these embodiments. That is, the scope of protection of the present disclosure should be construed according to the appended claims, and all technical ideas within the scope of equivalents thereof should be construed as being included in the scope of the present disclosure.

What is claimed is:

1. A panel board comprising:
a base plate;
an insulating plate coupled to the base plate and comprising a plurality of bus bar mounting grooves formed in parallel; and
rail-type mother bus bars inserted into the plurality of bus bar mounting grooves, respectively,
wherein the insulating plate comprises an inter-phase part partition wall formed at an inter-phase part between the bus bar mounting grooves to be higher than a height of the corresponding mother bus bar.

2. The panel board of claim 1, wherein the insulating plate comprises:
an assembly protrusion portion protruding from one end of a lower surface of the insulating plate; and
an assembly cut portion formed by cutting another end of the lower surface of the insulating plate.

3. The panel board of claim 1, wherein the insulating plate comprises:
a plurality of assembly protrusions protruding forward from one surface of the insulating plate; and
a plurality of assembly grooves formed as grooves in another surface of the insulating plate to correspond to the plurality of assembly protrusions, respectively.

4. The panel board of claim 1, wherein the insulating plate comprises:
an inner coupling block formed on a front end of a side wall of the insulating plate; and
an outer coupling block formed on a rear end of the side wall to correspond to the inner coupling block.

5. The panel board of claim 1, wherein the bus bar mounting groove comprises a bus bar fastening hole formed such that the mother bus bar is coupled.

6. The panel board of claim 1, wherein groove side wall forming a side surface of the bus bar mounting groove protrudes to a certain height, and the height of the groove side walls is lower than a height of the mother bus bar.

7. The panel board of claim 6, wherein the inter-phase part partition wall is arranged at a certain gap from the groove side wall.

8. The panel board of claim 6, wherein a gap groove of a certain depth is formed between the inter-phase part partition wall and the groove side wall.

9. The panel board of claim 6, wherein the inter-phase part partition wall is provided as a pair in a symmetrical manner at the inter-phase part between two adjacent phases.

10. A panel board comprising:
a base plate;
an insulating plate coupled to the base plate and comprising a plurality of bus bar mounting grooves formed in parallel; and
rail-type mother bus bars inserted into the plurality of bus bar mounting grooves, respectively,
wherein the insulating plate comprises a double protrusion portion arranged at an inter-phase part between the bus bar mounting grooves adjacent to each other, and
the double protrusion portion comprises:
a groove side wall protruding to a certain height from a side surface of the bus bar mounting groove;
an inter-phase part partition wall protruding from the inter-phase part; and
a gap groove formed between the groove side wall and the inter-phase part partition wall.

11. The panel board of claim 10, wherein a height of the groove side wall is lower than a height of the mother bus bar.

12. The panel board of claim 10, wherein the inter-phase part partition wall is higher than a height of the groove side wall and a height of the mother bus bar.

13. The panel board of claim 10, wherein the inter-phase part partition wall is provided as a pair in a symmetrical manner at the inter-phase part.
